(19) United States
(12) Patent Application Publication
(10) Pub. No.: US 2009/0047054 A1
(43) Pub. Date: Feb. 19, 2009

(54) Crayon

(76) Inventors: Michelle H. Moore, Oakboro, NC (US); Randall L. Moore, Oakboro, NC (US)

Correspondence Address: CHRISTOPHER D. HARRINGTON, SUITE 350, 5300 CORPORATE GROVE DRIVE SE, GRAND RAPIDS, MI, 49512, US

(21) Appl. No.: 11/891,590

(22) Filed: Aug. 13, 2007

(51) Int. Cl. B43K 29/00; B43K 19/00

(52) U.S. Cl. 401/52; 401/49

(57) ABSTRACT

A writing or drawing instrument, for use by persons who are physically challenged, comprises a body with a top and a tip, and where the body is tapered there between. A strap is installed onto the body for use in installing the instrument onto the hands or fingers of a user. The strap is preferentially comprised of an elastic that provides flexibility for conforming to the hands or fingers of the user and for providing a biasing pressure for retaining the instrument to the hands or fingers of the user. In the preferred embodiment, the instrument is a crayon.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to crayons for use in creating art work. More particularly, the present invention relates to crayons that can easily be used by persons who may have disabilities or infirmities that make it difficult to use conventionally sized and shaped crayons.

Crayons are typically sticks of colored wax that are shaped to conform to being held in a person's hand. Young children most often use crayons for drawing and coloring and the use of crayons in elementary schools is perhaps the most common activity associated with the product. Most people are familiar with the Crayola® brand crayons which are manufactured by Brinney & Smith and are famous for the myriad colors that are offered. As an artistic tool, crayons are not generally favored by professional artists owing to their limitations in the mixing of colors, however the volume of crayon based art works that are created by children far outnumber the works of professional artists and the humble crayon is responsible for the introduction of art to such children, some of whom will matriculate to the professional art world as adults. The typical crayon is a slender stick-like product that is approximately ⅜″ or more in diameter with a tapered tip which is used as the end for drawing and coloring purposes. The crayon body is typically covered with a paper wrap that not only provides information about the product (the type of color and the brand name) but which also guards the user's hand and fingers from direct contact with the colored wax. Crayons have been made from other substances, including colored greases and from compounds that use chalk, however the paraffin based Crayola® is clearly the most common type of crayon that is used today and will comprise the product that is termed a “crayon” within this specification.

Crayons obviously serve a useful purpose therefore in teaching art to school children and in allowing their creative ambitions to germinate. The benefits of this early entrée into artistic endeavors is not only for those who may posses both the ambition and skill for later development, but the exposure to artistic expression is thought to provide benefits to all children in broadening the mind and by instilling an appreciation for the artistic products of others. The effects are thought to spill over into all the facets of the learning process and enhance the educational experience. So it is important that all children, to the extent possible, have crayons available for use so they can explore their creative expressions and gain from this enriching experience.

Unfortunately many children, and many adults, possess disabilities that impair or prevent their use of crayons. Whether by injury, or through a disease process, or as a result of congenital limitations, there are many who find it difficult to grasp and use the conventional crayon and who are therefore excluded from an activity that is both educationally important and recreationally stimulating. As a result there has been a longstanding need for an artistic tool that provides the simplicity of a crayon and that is easily usable by those children (and others) who possess limitations.

There have been efforts made in the prior art to provide tools to assist persons with limitations. For instance, in U.S. Pat. No. 5,553,324 (Emerson) a “gripping aid” is disclosed that is used to assist a person who needs additional strength and support in gripping an object. The gripping aid can be used to help hold writing utensils such as pens and pencils, and would be expected to assist in gripping a regular crayon as well. The gripping aid though is separate from such objects and it requires a series of steps to properly fit the aid to the user's wrist and hand, and then to the object being gripped. A comparable aid is taught in U.S. Pat. No. 5,853,210 (Robinson) and resembles a glove that has a strap that allows items such as writing utensils or a toothbrush to be fitted thereon. This allows the user to hold the item without having to actually grip it. In both of the foregoing devices the gripping aids are integrally related to the user's hand/wrist and require installation separate from the fitting of the item to the used to the aid.

Another gripping aid is disclosed in U.S. Pat. No. 4,523,781 (Brody) arid comprises a potato shaped tool that fits within the palm of a user. The tool includes a number of orifices that receive items such as a fork or a pen thereby allowing the user to hold such items and to use them when gripping them would not be possible. Similarly, in U.S. Pat. No. 4,035,865 (McRae, et al) a ball shaped tool is provided with an orifice for holding items such as forks or pens. As was the case with Brody, the invention assists people who do not have the capacity to fully close their fingers around a small item. In the same track, U.S. Pat. No. 5,383,737 (Urion) discloses a gripping aid that conforms, in part, to the palm of a user. In this case the gripping aid is allowed to rest on the surface of a table where the user can add a writing implement to the aid and then guide it for purposes of writing or drawing. Lastly, in U.S. Design Pat. No. D270,945 (Kohn) another ball shaped aid is disclosed for use in holding an item like a writing utensil. The foregoing aids interface between the item the user desires to grip and the user's hand. The item in each case must be installed separately into the aid and adjustments are made to retain the item in an affirmative manner.

The problems with the prior art aids are many and include the fact that the user is either faced with an installation procedure for each item he/she desires to use or they must rely on others to make the installation. In addition, the use of an aid requires installation of the item which adds to the frustration when, as would be the case in the use of crayons, it is desired to change colors from time to time. Multiple aids can be acquired to offset this disadvantage but the aids are costly and the prospect of obtaining a number of them for each student in a classroom could be a prohibitive factor. Another aspect to the prior art devices is that the interposition of an aid between the user and the item being used does separate the user from the activity. In such an instance there is only indirect contact made by the user with the item (crayon) and this will diminish the ability of the user to adequately express his/herself.

The present invention overcomes the long standing problems associated with the gripping of items, specifically a crayon, by person with physical limitations. This is accomplished in a manner that is cost effective as well as being more compatible with the artistic expression sought by the user. These attributes and other benefits and features of the present invention will be explained herein.

### SUMMARY OF THE INVENTION

The present invention is a crayon for use by persons with limitations that impair their ability to grip a conventional crayon product, the crayon comprising a crayon body with a top and a tip and where the crayon body is tapered towards said tip. In addition, the crayon body has a flexible strap that is attached to the crayon body on the top side and where said strap elastically retains a user's hand to the top of the crayon body. The crayon of the present invention is provided in a plurality of colors.

### BRIEF DESCRIPTION OF THE DRAWINGS

FIG. 1 is an isometric view of the crayon of the present invention.

FIG. 2 is a top view of the crayon of FIG. 1.

FIG. 3 is a bottom view of the crayon of FIG. 1.

FIG. 4 is a side elevational view of the strap of the present invention.

### DETAILED DESCRIPTION OF THE PREFERRED EMBODIMENTS

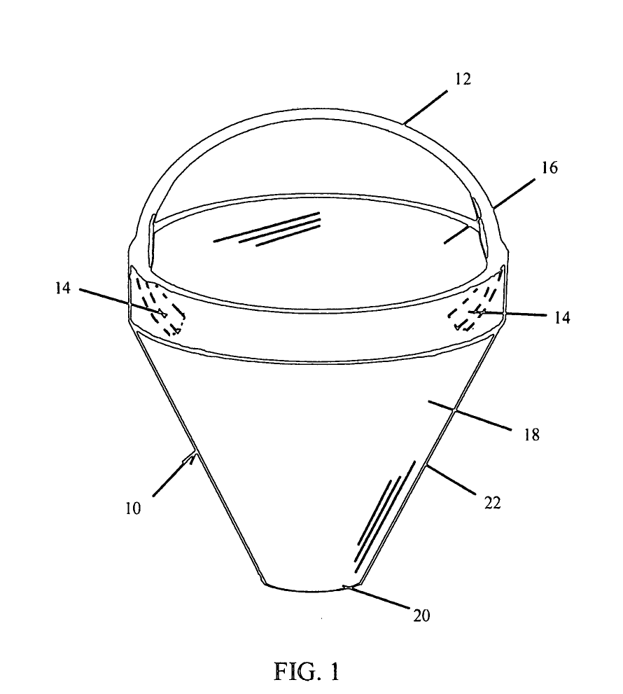

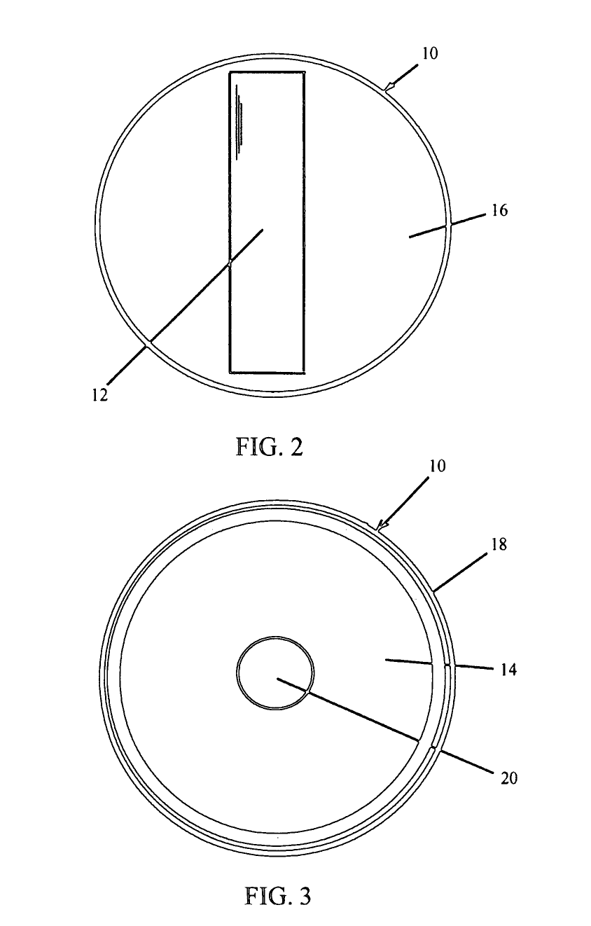

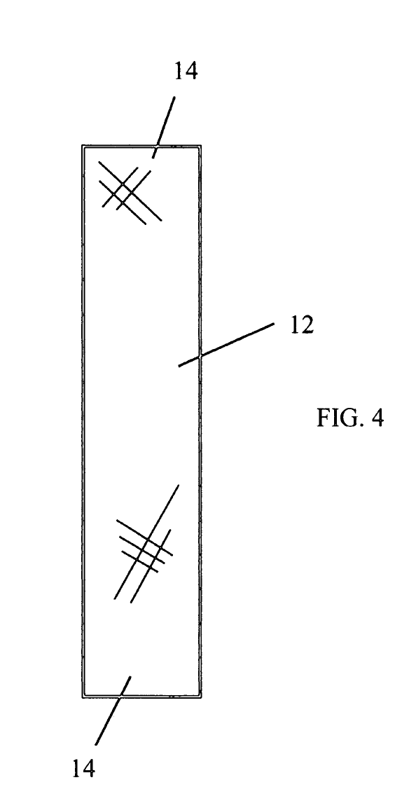

A novel crayon, or similar writing or drawing instrument, in accordance with the present invention is shown in the drawings and is described in detail herein. Turning to FIGS. 1, 2, 3 and 4, a writing or drawing instrument, in this instance a crayon 10 is shown with strap 12. The crayon 10 is comprised of the crayon top 16, the crayon body 18 and the crayon tip 20. The crayon body 18 is typified by the taper 22. The strap 12 also includes the strap ends 14 (shown in phantom).

The crayon of the present invention is preferentially sized to be handled by children or adults and to provide a means for holding the crayon in a constant position so the physically challenged person does not have to form a grip around the crayon. The preferred embodiment is a crayon body that is approximately 1 7/16 inches in height and with a crayon top that is 1 15/16 inches in width. The crayon body is tapered to form a tip, the taper being inverse (decreasing in diameter) from the top to the tip. The tip is the point of contact with the drawing media, such as paper, poster board, canvas or the like and the tip can be shaped to control the size of the line that is actually drawn by the user.

Variations on the crayon dimensions and shape can be made without departing from the scope of the present invention. In addition, it is understood that the crayon can be fashioned in a multitude of colors, as crayons would normally be offered. The generalized shape of the preferred embodiment allows for a blunter top as opposed to the conventional crayon which is “stick” shaped. The wider top gives the physically challenged person a better means to grip the preferred embodiment and for control than would otherwise be the case.

The strap is preferentially an elastic strap, formed from elastic material that is approximately 4 inches long and approximately one inch in width. The strap ends are embedded in the crayon top near the perimeter of the top as shown in the drawings, leaving enough of the strap remaining in order to form a handle-like strap above the crayon top. Since the crayon material is typically a paraffin based wax, the strap ends can be placed in the mold for the crayon as the wax is injected. Once cooled, the strap ends are affixed to the crayon top in a robust manner. The arrangement of the strap allows the user the insert either his/her fingers or their hand into the space provided between the crayon top and the underside of the strap. The strap, being elastic, will provide a biasing pressure that allows the strap to conform to the user's fingers or hand and will hold the crayon snugly to the user's fingers or hand. Also, being elastic, the strap in the preferred embodiment will allow persons with differing sized hands and fingers to use the invention. This also expands the use of the present invention to allow for both children and adult users. It is possible for the strap to be fabricated from two pieces of one inch wide fabric where the free ends would be fitted with mechanical fastening fabric such as Velcro® thereby allowing the fabric straps to be adjusted for each user. It is thought, however, that the use of this approach would be more costly and would not produce any additional effectiveness or ease of use than the preferred embodiment. Nonetheless, the use of this approach is an alternate approach to the preferred embodiment.

Once the user has the crayon placed on their fingers or hand, with the crayon top positioned closest to the user and the crayon tip pointed away from the user's fingers or hand, the invention is ready to be used. The user need only to place the tip of the crayon on a writing or drawings surface and with the application of a little pressure the crayon will scribe a line as the user moves his/her hand. In the event the user desires to change the color he/she is using, the crayon can be easily exchanged for another one of the same construction as taught herein, but sporting a different color.

The objective of the present invention is to provide a tool that allows people who are physically challenged to participate in artistic endeavors. The use of a crayon as such a tool comes from the fact that crayons are provided in numerous colors and the paraffin base used for crayons is compatible with the embedding of the strap therein. It is possible however to use a different substance for the writing instrument of the present invention, such as a chalk or grease based body. While these are generally less compatible with the fabrication process contemplated for the crayon product of the preferred embodiment, such substitutions could be made without departing from the present invention. In some instance it may be required to fasten the strap in an alternate manner, such as gluing it to the sides of the body, however the retention of the shape and the configuration of the strap would remain consistent with the present invention. Similarly, a writing instrument in accordance with the present invention could be fashioned as a pencil with a wood sheath that possesses the physical characteristics of the preferred embodiment. Such an instrument could be used for writing or drawing and would fulfill the same objectives.

The advantages of the preferred embodiment include the low cost that is possible through the use of a crayon body and a simple elastic strap. As compared to the prior art, the present invention achieves a high degree of functionality in assisting challenged persons with the use of a writing instrument. This effectiveness not only results in a low cost for each such crayon, but it allows for more crayons to be made available thereby opening up a whole palette of colors to the user. The low cost is also facilitative for those institutions such as schools or therapy clinics that typically confront tight budgets. The availability of a tool such as the present invention that can be purchased for a low cost allows the institution a much needed means to expand their abilities without having to sacrifice some other equipment they require as well.

It is understood and appreciated that the teachings herein are intended to illustrate the invention. Variations and modifications that can be made by one skilled in the art would still fall within the scope of the present invention and would not be departures therefrom.

We claim:

1. A writing or drawing instrument for use by persons who are physically challenged, comprises:
A body with a top, and a tip;
A flexible strap with strap ends
Where said body is inversely tapered between said top and said tip, and where the strap is affixed to the top by the strap ends allowing enough length of said strap so as to be compatible with the installation of the person's fingers or hand in between the strap and the top and for the fingers or hands to be biasedly retained.

2. The instrument of claim number 1, where the instrument is a crayon.

3. The instrument of claim number 1, where the strap is comprised of an elastic strap.

4. The instrument of claim number 2, where the crayon is selected from a plurality of colors.

5. A crayon for use as a drawing or writing instrument by a person who is physically challenged, comprises:
A body with a top, and a tip;
A flexible strap with strap ends
Where said body is inversely tapered between said top and said tip, and where the strap is affixed to the top by the strap ends allowing enough length of said strap so as to be compatible with the installation of the person's fingers or hand in between the strap and the top and for the fingers or hands to be biasedly retained.

6. The crayon of claim number 5, where the crayon is selected from a plurality of colors.

7. The crayon of claim number 5, where the strap is comprised of an elastic material.

8. The crayon of claim number 7, where the elastic material is approximately 4 inches long and approximately one inch in width.

9. The crayon of claim number 7, where the strap is affixed to the crayon top through the embedding of the strap ends in the crayon body.

10. The crayon of claim number 5, where the crayon top is approximately 1 15/16 inches in width and where the crayon is approximately 1 7/16 inches between said tip and said top.

11. A crayon for use as a drawing or writing instrument by a person who is physically challenged, comprises:
A body with a top, and a tip;
A flexible strap with strap ends, where said strap is comprised of an elastic material;
Where said body is inversely tapered between said top and said tip, and where the strap is affixed to the top by the strap ends where the strap ends are embedded in the crayon body allowing enough remaining length of said strap so as to be compatible with the installation of the person's fingers or hand in between the strap and the top and for the fingers or hands to be biasedly retained.

12. The crayon of claim number 11, where the crayon is selected from a plurality of colors.

13. The crayon of claim number 11, where the elastic material is approximately 4 inches long and approximately one inch in width.

14. The crayon of claim number 11, where the crayon top is approximately 1 15/16 inches in width and where the crayon is approximately 1 7/16 inches between said tip and said top.
